(19) United States
(12) Patent Application Publication
(10) Pub. No.: US 2014/0360362 A1
(43) Pub. Date: Dec. 11, 2014

(54) METHOD AND SYSTEMS FOR PARTICLE SEPARATION IN AN EXHAUST GAS RECIRCULATION SYSTEM

(71) Applicant: General Electric Company, Schenectady, NY (US)

(72) Inventors: Eric David Peters, Lawrence Park, PA (US); Paul Lloyd Flynn, Lawrence Park, PA (US)

(21) Appl. No.: 13/911,304

(22) Filed: Jun. 6, 2013

(51) Int. Cl. F01N 3/037; B03C 1/02; B01D 45/12; B01D 45/08

(52) U.S. Cl. CPC F01N 3/037; B01D 45/08; B03C 1/02; B01D 45/12
USPC 95/28; 96/1; 95/267; 95/269; 55/462; 55/443; 55/338.1

(57) ABSTRACT

Various methods and systems are provided for separating particles within a gas flow traveling through a gas flow passage of an engine. In one embodiment, a particle separator includes a plurality of vanes positioned across a gas flow passage through which gas flow passes, the plurality of vanes angled with respect to a flow direction of the gas flow, and a particle trap for collecting separated particles, the particle trap disposed in the gas flow passage.

### FIELD

Embodiments of the subject matter disclosed herein relate to an engine, engine components, and an engine system, for example.

### BACKGROUND

Engine components may degrade over time, resulting in internally generated wear debris or particles. Wear debris particles may pass through an exhaust system of the engine and exit the engine through a muffler or exhaust stack. Engines may utilize recirculation of exhaust gas from the engine exhaust system to an intake system, a process referred to as exhaust gas recirculation (EGR), to reduce regulated emissions. If the engine uses EGR, a portion of the exhaust carrying wear debris may be cooled and mixed with the charge air in the intake system to be used in the combustion process. When recirculated, internally generated particles may pass through the rest of the engine system, thereby leading to further degradation of engine components.

### BRIEF DESCRIPTION

In one embodiment, a particle separator comprises a gas flow passage comprising a wall and an interior defined by the wall for passage of a gas flow, a plurality of vanes attached to the gas flow passage and positioned across the interior of the gas flow passage, the plurality of vanes angled with respect to a central axis of the interior, and a particle trap for collecting separated particles, the particle trap attached to the gas flow passage.

In this way, particles may be separated from the gas flow stream flowing through the gas flow passage. Separated particles may be collected with the particle separating element, thereby reducing an amount of particles traveling downstream and back into an intake manifold of the engine. As such, particle recirculation and engine degradation due to recirculated particles may be reduced.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a schematic diagram of an embodiment of a rail vehicle with an engine.

FIG. 2 shows a position of a particle separator within an engine system according to an embodiment of the invention.

FIG. 3 shows a particle separator according to a first embodiment of the invention.

FIG. 4 shows a particle separator coupled to a flow passage of an engine system according to an embodiment of the invention.

FIGS. 5-6 show a particle separator according to a second embodiment of the invention.

FIG. 7 is a flow chart of a method for collecting particles in a gas flow with a flow separator according to an embodiment of the invention.

### DETAILED DESCRIPTION

The following description relates to various embodiments of separating particles within a gas flow traveling through a gas flow passage of an engine. In one example, particles or wear debris traveling in the gas flow may be separated out from the gas with a particle separator positioned within the gas flow passage. The gas flow passage may include one or more of an exhaust gas recirculation (EGR) passage or an intake passage, downstream of a charge air cooler (CAC). The particle separator may include a plurality of overlapping and angled vanes which allow gas to pass through the vanes. However, the denser wear debris particles may not pass through the vanes. As such, these particles may be trapped at a bottom of the gas flow passage. In some examples, the particle separator may include a particle trap for collecting the trapped particles. The particle trap may be recessed from the gas flow passage in order to avoid flow restriction from the trapped particles. Gas that passes through the particle separator may then have fewer particles or wear debris than the gas entering the particle separator. As such, the particle separator may reduce an amount of particles traveling downstream to the intake manifold of the engine without substantially increasing flow resistance through the gas flow passage, thereby reducing further engine degradation.

The approach described herein may be employed in a variety of engine types, and a variety of engine-driven systems. Some of these systems may be stationary, while others may be on semi-mobile or mobile platforms. Semi-mobile platforms may be relocated between operational periods, such as mounted on flatbed trailers. Mobile platforms include self-propelled vehicles. Such vehicles can include on-road transportation vehicles, as well as mining equipment, marine vessels, rail vehicles, and other off-highway vehicles (OHV). For clarity of illustration, a locomotive is provided as an example of a mobile platform supporting a system incorporating an embodiment of the invention.

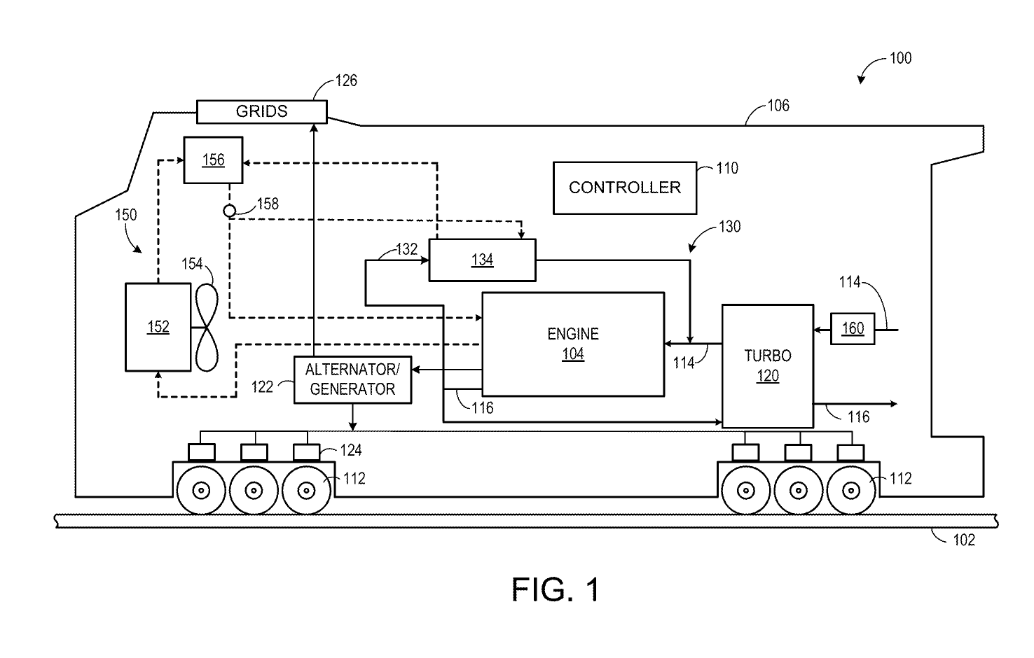

Before further discussion of the approach for separating and removing particles from a flow passage in an engine system, an example of a platform is disclosed in which an engine cylinder bank and EGR system may be configured for an engine in a vehicle, such as a rail vehicle. For example, FIG. 1 shows a block diagram of an example embodiment of a vehicle system 100, herein depicted as a rail vehicle 106 (e.g., locomotive), configured to run on a rail 102 via a plurality of wheels 112. As depicted, the rail vehicle 106 includes an engine 104. In other non-limiting embodiments, the engine 104 may be a stationary engine, such as in a power-plant application, or an engine in a marine vessel or other off-highway vehicle propulsion system as noted above.

The engine 104 receives intake air for combustion from an intake passage 114. The intake passage 114 receives ambient air from an air filter 160 that filters air from outside of the rail vehicle 106. Exhaust gas resulting from combustion in the engine 104 is supplied to an exhaust passage 116. Exhaust gas flows through the exhaust passage 116, and out of an exhaust stack of the rail vehicle 106. In one example, the engine 104 is a diesel engine that combusts air and diesel fuel through compression ignition. In other non-limiting embodiments, the engine 104 may combust fuel including gasoline, kerosene, natural gas, biodiesel, or other petroleum distillates of similar density through compression ignition (and/or spark ignition).

In one embodiment, the rail vehicle 106 is a diesel-electric vehicle. As depicted in FIG. 1, the engine 104 is coupled to an electric power generation system, which includes an alternator/generator 122 and electric traction motors 124. For example, the engine 104 is a diesel engine that generates a torque output that is transmitted to the generator 122 which is mechanically coupled to the engine 104. The generator 122 produces electrical power that may be stored and applied for subsequent propagation to a variety of downstream electrical components. As an example, the generator 122 may be electrically coupled to a plurality of traction motors 124 and the generator 122 may provide electrical power to the plurality of traction motors 124. As depicted, the plurality of traction motors 124 are each connected to one of a plurality of wheels 112 to provide tractive power to propel the rail vehicle 106. One example configuration includes one traction motor per wheel. As depicted herein, six pairs of traction motors correspond to each of six pairs of motive wheels of the rail vehicle. In another example, alternator/generator 122 may be coupled to one or more resistive grids 126. The resistive grids 126 may be configured to dissipate excess engine torque via heat produced by the grids from electricity generated by alternator/generator 122.

The vehicle system 100 includes a turbocharger 120 that is arranged between the intake passage 114 and the exhaust passage 116. The turbocharger 120 increases air charge of ambient air drawn into the intake passage 114 in order to provide greater charge density during combustion to increase power output and/or engine-operating efficiency. The turbocharger 120 may include a compressor (not shown) which is at least partially driven by a turbine (not shown). While in this case a single turbocharger is included, the system may include multiple turbine and/or compressor stages.

In some embodiments, the vehicle system 100 may further include an aftertreatment system coupled in the exhaust passage upstream and/or downstream of the turbocharger 120. In one embodiment, the aftertreatment system may include a diesel oxidation catalyst (DOC) and a diesel particulate filter (DPF). In other embodiments, the aftertreatment system may additionally or alternatively include one or more emission control devices. Such emission control devices may include a selective catalytic reduction (SCR) catalyst, three-way catalyst, NOₓ trap, or various other devices or systems.

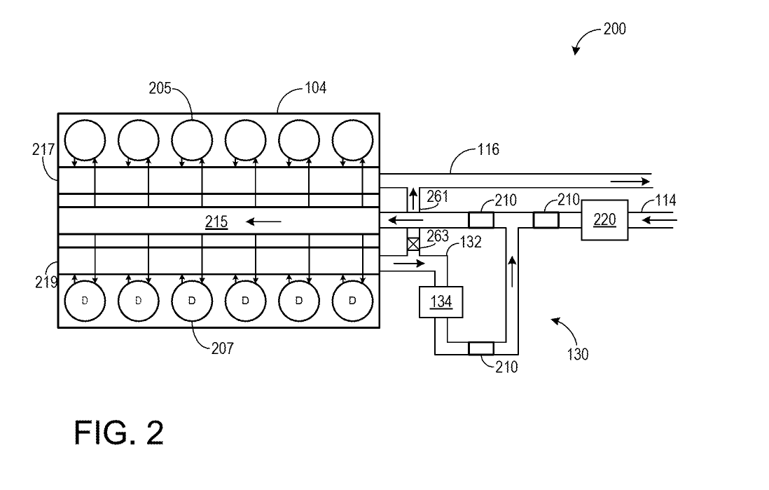

The vehicle system 100 further includes an exhaust gas recirculation (EGR) system 130 coupled to the engine 104, which routes exhaust gas from an exhaust passage 116 of the engine 104 to the intake passage 114 downstream of the turbocharger 120. In some embodiments, the exhaust gas recirculation system 130 may be coupled exclusively to a group of one or more donor cylinders of the engine, as shown in FIG. 2 (discussed further below). As depicted in FIG. 1, the EGR system 130 includes an EGR passage 132 and an EGR cooler 134 to reduce the temperature of the exhaust gas before it enters the intake passage 114. By introducing exhaust gas to the engine 104, the amount of available oxygen for combustion is decreased, thereby reducing the combustion flame temperatures and reducing the formation of nitrogen oxides (e.g., NOₓ).

In some embodiments, the EGR system 130 may further include an EGR valve for controlling an amount of exhaust gas that is recirculated from the exhaust passage 116 of the engine 104 to the intake passage 114 of engine 104. The EGR valve may be an on/off valve controlled by the controller 110, or it may control a variable amount of EGR, for example. As shown in the non-limiting example embodiment of FIG. 1, the EGR system 130 is a high-pressure EGR system. In other embodiments, the vehicle system 100 may additionally or alternatively include a low-pressure EGR system, routing EGR from downstream of the turbine to upstream of the compressor.

As depicted in FIG. 1, the vehicle system 100 further includes a cooling system 150. The cooling system 150 circulates coolant through the engine 104 to absorb waste engine heat and distribute the heated coolant to a heat exchanger, such as a radiator 152. A fan 154 may be coupled to the radiator 152 in order to maintain an airflow through the radiator 152 when the vehicle 106 is moving slowly or stopped while the engine is running. In some examples, fan speed may be controlled by a controller, such as controller 110.

Coolant which is cooled by the radiator 152 enters a tank 156. The coolant may then be pumped by a water, or coolant, pump (not shown) back to the engine 104 or to another component of the vehicle system. As shown in FIG. 1, coolant may be pumped from the tank 156 to the EGR cooler 134 such that a temperature of exhaust gas flowing through the EGR cooler 134 may be reduced before it enters the intake passage 114. A temperature of the coolant may be measured by a coolant temperature sensor 158 before it enters the engine 104 or the EGR cooler 134. Coolant that passes through the EGR cooler 134 then flows back to the tank 156. In other embodiments, the EGR cooler and the radiator may have separate tanks.

The rail vehicle 106 further includes an engine controller 110 (referred to hereafter as the controller) to control various components related to the rail vehicle 106. As an example, various components of the vehicle system may be coupled to the controller 110 via a communication channel or data bus. In one example, the controller 110 includes a computer control system. The controller 110 may additionally or alternatively include a memory holding non-transitory computer readable storage media (not shown) including code for enabling on-board monitoring and control of rail vehicle operation.

The controller 110 may receive information from a plurality of sensors and may send control signals to a plurality of actuators. The controller 110, while overseeing control and management of the rail vehicle 106, may be configured to receive signals from a variety of engine sensors, as further elaborated herein, in order to determine operating parameters and operating conditions, and correspondingly adjust various engine actuators to control operation of the rail vehicle 106. For example, the engine controller 110 may receive signals from various engine sensors including, but not limited to, engine speed, engine load, intake manifold air pressure, boost pressure, exhaust pressure, ambient pressure, ambient temperature, exhaust temperature, particulate filter temperature, particulate filter back pressure, engine coolant pressure, gas temperature in the EGR cooler, the presence of wear particles, or the like. Correspondingly, the controller 110 may control the rail vehicle 106 by sending commands to various components such as the traction motors 124, the alternator/generator 122, cylinder valves, fuel injectors, a notch throttle, or the like. Other actuators may be coupled to various locations in the rail vehicle.

Wear debris, or particles, may be generated within the engine system as engine components degrade. For example, particles or non-combustion products produced in the engine may include power assembly debris, valve train debris, recirculated components of the charge air system (e.g., from the CAC), or the like. Particles may be recirculated through the engine via the EGR system. Recirculation of these particles may not be tolerated by the engine components and may result in further engine degradation. In some cases, wear particles may be generated from wear of metallic engine components.

A particle separator or particle separating element may be positioned within a gas flow passage in the engine to separate particles and/or wear debris from the gas flowing through the gas flow passage. In one example, a particle separator may include a filter element. However, over time, trapped particles may build up on the filter and increase airflow resistance through the gas flow passage. Instead, non-damming particle separators may remove particles while not significantly increasing gas flow resistance.

The particles or wear debris in a gas flow (e.g., EGR flow) in the engine may have a higher density than the gas they are traveling in. As such, the higher density particles may be separated from the gas flow stream by using different particle separating elements which may not increase airflow resistance. As such, these particle separating elements may be different from a filter element, such as an air filter. One example of such a particle separator or particle separating element may include a cyclonic or vortex-type particle separator which creates a rotating flow, or vortices, in the gas flow stream, thereby causing separation of the higher density particles from the main gas flow stream. The higher density particles may then be bled off to a lower pressure location.

In another example, a particle separator or particle separating element may include an inertial-type particle separator. The inertial-type particle separator may include vanes or slats positioned within the gas flow passages and angled with respect to a direction of the gas flow. As such, the gas flow is required to flow around tight bends between the angled vanes. However, the higher density particles will not be able to go through the tight bends, thereby causing the higher density particles to fall out of the gas flow stream. The particles may then be collected or trapped in a section or chamber within the gas flow passage. As discussed above, the particles circulating through the gas flow passage may be metallic. By positioning a magnet within a particle trap or collection chamber, the particles may be attracted to the magnet and further separated from the gas flowing through the gas flow passage. In one example, the magnet may be positioned at the bottom of the particle trap.

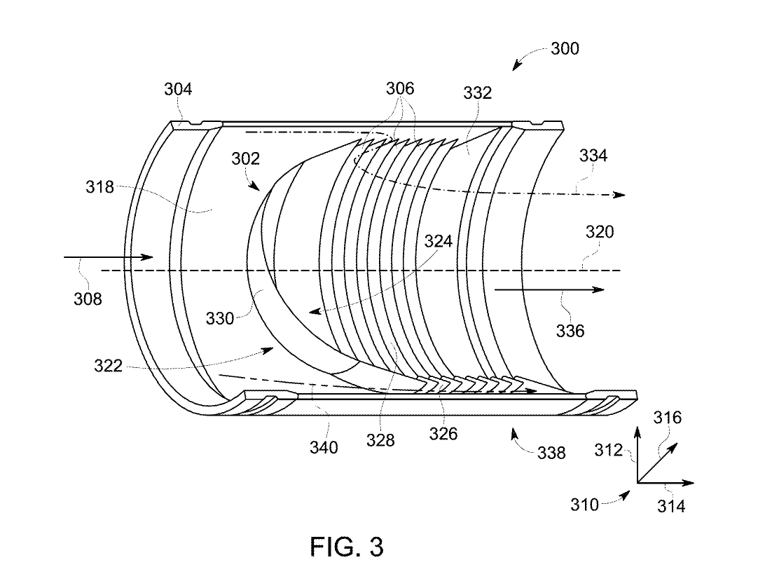

Thus, by positioning one or more of the particle separators described above in a gas flow passage containing at least some exhaust gas, wear particles within the gas flow passage may be separated and removed from the gas flow, thereby reducing further engine degradation. Further details on the particle separators are discussed below with reference to FIGS. 3-7.

FIG. 2 shows example of positions of a particle separator, introduced above, within an engine system 200. As engine system 200 is part of vehicle system 100, components in FIG. 2 may be the same as the components described above with respect to FIG. 1. The engine 104 receives intake air for combustion from an intake, such as an intake manifold 215. The intake may be any suitable conduit or conduits through which gases flow to enter the engine. For example, the intake may include the intake manifold 215, the intake passage 114, and the like. The intake passage 114 receives ambient air from an air filter (shown in FIG. 1) that filters air from outside of a vehicle in which the engine 104 may be positioned. The intake passage 114 may include a charge air cooler (CAC) 220 positioned downstream from the turbocharger (such as the turbocharger 120 shown in FIG. 1). As such, the CAC 220 may cool the compressed charge air before entering the intake manifold 215.

Exhaust gas resulting from combustion in the engine 104 is supplied to an exhaust, such as exhaust passage 116. The exhaust may be any suitable conduit through which gases flow from the engine. For example, the exhaust may include an exhaust manifold 217, the exhaust passage 116, and the like.

In the embodiment depicted in FIG. 2, the engine 104 is a V-12 engine having twelve cylinders. In other examples, the engine may be a V-6, V-8, V-10, V-16, I-4, I-6, I-8, opposed 4, or another engine type. As depicted, the engine 104 includes a subset of non-donor cylinders 205, which includes six cylinders that supply exhaust gas exclusively to a non-donor cylinder exhaust manifold 217, and a subset of donor cylinders 207, which includes six cylinders that supply exhaust gas exclusively to a donor cylinder exhaust manifold 219. In other embodiments, the engine may include at least one donor cylinder and at least one non-donor cylinder. For example, the engine may have four donor cylinders and eight non-donor cylinders, or three donor cylinders and nine non-donor cylinders. It should be understood, the engine may have any desired numbers of donor cylinders and non-donor cylinders, with the number of donor cylinders typically lower than the number of non-donor cylinders.

As depicted in FIG. 2, the non-donor cylinders 205 are coupled to the exhaust passage 116 to route exhaust gas from the engine to atmosphere (after it passes through the turbocharger 120, shown in FIG. 1). The donor cylinders 207, which provide EGR, are coupled exclusively to an EGR passage 132 of an EGR system 130 which routes exhaust gas from the donor cylinders 207 to the intake passage 114 of the engine 104, and not to atmosphere. The EGR passage 132 may route exhaust gas to the intake passage 114 either downstream of the turbocharger 120 (high pressure EGR) or upstream of the turbocharger 120 (low pressure EGR).

Exhaust gas flowing from the donor cylinders 207 to the intake passage 114 passes through the EGR cooler 134, as described above for FIG. 1. Additionally, in some embodiments, the EGR system 130 may include an EGR bypass passage 261 that is configured to divert exhaust from the donor cylinders back to the exhaust passage. The EGR bypass passage 261 may be controlled via a valve 263. The valve 263 may be configured with a plurality of restriction points such that a variable amount of exhaust gas is routed to the exhaust passage, in order to provide a variable amount of EGR to the intake.

A particle separator 210 may be positioned at a location within engine system 200. In some embodiments, multiple particle separators 210 are positioned in the engine system for respectively collecting and separating particles (e.g., debris) at several locations within the engine system. As shown in FIG. 2, in one example, a first particle separator 210 is positioned in the intake passage 114, downstream of an outlet of the EGR passage 132 of EGR system 130. In another example, a second particle separator 210 is positioned (alternatively or additionally) in the intake passage 114, downstream of the CAC 220 to collect foreign object debris from the CAC 220 and intake passage tubing. In yet another example, a third particle separator 210 is positioned (alternatively or additionally) in the EGR passage 132, downstream of the EGR cooler 134.

As noted above, there may be one or more particle separators positioned in the engine system 200, as shown in FIG. 2. For example, there may only be one particle separator 210 located in the EGR passage 132, downstream of the EGR cooler 134. In another example, there may be one particle separator 210 in the EGR passage 132, downstream of the EGR cooler 134, and one particle separator 210 in the intake passage 114, downstream of the CAC 220. In yet another example, there may only be one particle separator 210 positioned in the intake passage 114, downstream of the outlet of the EGR passage 132 of EGR system 130 and the CAC 220. As such, one or more particle separators 210 may be positioned in one or all of the locations shown in FIG. 2.

The particle separator may include a particle separating element, such as angled vanes and/or a filter, and a particle trap. In one example, the particle separating element and the particle trap may be positioned within a flow passage segment. The flow passage segment may then be positioned within a gas flow passage coupled to the engine, such as one of the gas flow passages described above. Alternatively, the particle separating element may be positioned within and integrated into the gas flow passage coupled to the engine. In this example, the particle trap may be positioned within and/or attached to the gas flow passage, proximate to the particle separating element.

As discussed above, the particle separator may include a particle trap for trapping foreign debris traveling through the gas flow passage. The particle trap may include a magnet for attracting and increasing the collection of particle debris. The particle trap magnet may be chosen based on the location or position of the particle separator in the engine system. Specifically, a strength of the magnet may be chosen based on a gas flow rate through the gas flow passage in which the particle separator is positioned and a temperature of the gas flowing through the gas flow passage. For example, if the particle separator is positioned downstream of the EGR cooler, as shown in FIG. 2 above, the magnet may be coated with a temperature resistant material. The magnet strength in this example may then be higher than if the magnet was not coated. In another example, the magnet may be positioned underneath a base material of the particle separator housing to shield the magnet from direct contact with the gas flow. Further, the magnet strength may be based on a flow rate through a gas flow passage in which the particle separator is installed. For example, the particle trap magnet may have a higher magnet strength in a gas flow passage with a higher gas flow rate than a gas flow passage with a lower gas flow rate. As a non-limiting example, a rare earth magnet such as Neodymium may be used in a particle separator placed in the gas flow passage with the higher gas flow rate.

Further, the particle trap magnet may also be chosen based on the type of particle separator, the size of the gas flow passage in which the particle trap is placed, and the size and shape of the particle trap. For example, the shape of the magnet may be chosen such that the magnet fits in the particle trap. As discussed further below with respect to FIGS. 3-6, the magnet may be annular, bar-shaped, or another type of shape based on the shape of the particle trap. For example, if the particle trap is annular and extends around a circumference of the gas flow passage, the magnet may be annular. In this example, the magnet may have a diameter substantially equal to or close to the diameter of the flow passage. In another example, if the particle trap is only at a bottom of the gas flow passage, the magnet may be flat or bar-shaped, with a length of the magnet based on a length of the particle trap.

As discussed above, one type of particle separator positioned in a flow passage of an engine system may include an inertial-type particle separator. FIG. 3 shows a first embodiment of an inertial-type particle separator 300. FIG. 3 includes a coordinate system 310 including a vertical axis 312, a horizontal axis 314, and a lateral axis 316. As shown in FIG. 3, the particle separator 300 includes a particle separating element 302 positioned within a gas flow passage 304. The gas flow passage 304 may be an EGR passage (such as EGR passage 132 shown in FIGS. 1-2) or an intake passage (such as intake passage 114 shown in FIGS. 1-2). Further, the gas flow passage 304 has a wall 318. The wall 318 is an interior wall forming a first diameter of the gas flow passage 304. Further, an interior of the gas flow passaged is defined by the wall 318.

The particle separating element 302 includes a plurality of overlapping and angled vanes 306 (also referred to as fins). Each vane of the plurality of vanes 306 is angled with respect to a flow direction of a gas flow 308 flowing through the gas flow passage 304. As shown in FIG. 3, the flow direction of the gas flow 308 is in a horizontal direction, with respect to the horizontal axis 314. A central axis 320 of the gas flow passage 304 is parallel to the horizontal axis 314. Specifically, the central axis 320 is a central axis of the interior of the gas flow passage 304. The vanes 306 are angled away from the central axis 320 and toward the wall 318 of the gas flow passage 304. Specifically, the vanes 306 are angled at an angle measured from the central axis 320. The angle may be within a range of 30-75°. In one example, a degree of angling of the vanes 306 may be 45°. In another example, the degree of angling of the vanes 306 may be 65°. Other degrees of angling are also within the scope of this disclosure. The degree of angling may depend on a size of the particles that are to be separated from the gas flow. For example, the degree of angling may be determined such that no particles greater than a certain size (e.g., maximum particle size) may pass through the vanes and exit the gas flow passage to enter the intake manifold of the engine.

Similarly, a spacing or distance between the vanes 306 may be determined based on a maximum particle size for particle separation. For example, particles greater than the maximum particle size may not pass through the vanes and are subsequently trapped and/or collected within the particle separator. As such, the spacing between the vanes 306 may be smaller than the maximum particle size. In another example, the spacing between the vanes 306 may be larger than the maximum particle size. For example, if the vanes 306 are angled such that the heavier particles cannot bend around the vanes, the particles may not pass through. Thus, in this case, the spacing between the vanes 306 may be slightly larger than the maximum particle size. For example, if the maximum particle size is in a range of 0.5-1.9 mm, the spacing between the vanes 306 may be in the range of 0.5-1.9 mm. In another example, the spacing between the vanes 306 may greater than 1.9 mm. For example, the spacing between the vanes may be in a range of 1.9-2.5 mm. Other distances between the vanes 306 outside of these listed ranges may also be within the scope of this disclosure.

Vane spacing and degree of angling may further be based on a gas flow resistance requirement. For example, as the spacing between the vanes 306 decreases and the degree of angling of the vanes 306 increases, the gas flow resistance (e.g., pressure drop from one side of the particle to the other side) within the gas flow passage 304 may increase. Thus, vane spacing and degree of angling may be chosen such that gas flow resistance is not increased above a threshold level while still reducing the amount of particles passing downstream from the particle separating element 302.

The particle separating element 302 has a conical or bullet-like shape. An upstream or outer surface 322 of the particle separating element 302 is convex while a downstream or inner surface 324 of the particle separating element 302 is concave. The convex outer surface 322 is formed by a first or outer side 326 of the plurality of vanes 306. The concave inner surface 324 is formed by a second or inner side 328 of the plurality of vanes 306.

Each vane is annular with a diameter less than or equal to the first diameter of the gas flow passage 304. The plurality of vanes 306 include a first vane 330 at an upstream end of the particle separator 300 and a second vane at a downstream end of the particle separator 300. The second vane may be referred to as a last vane 332 of the particle separating element 302. The last vane 332 is the only vane of the particle separating element 302 which contacts the wall 318 of the gas flow passage 304.

The first vane 330 includes a crown with a spherical top. Specifically, the first vane 330 is convex, in the direction of gas flow, and has a conical shape. However, the top, or crown, of the first vane 330 is spherical. The first vane 330 widens outward, toward the wall 318, from the spherical top to an edge, the edge proximate to a subsequent, second vane (different from the last vane 332) of the plurality of vanes 306. The first vane 330 has a first vane diameter, measured from the edge of the first vane 330. The first vane diameter is smaller than the first diameter of the gas flow passage 304. For example, the diameter of the gas flow passage may be within a range of 4.5-6 inches. In one example, if the diameter of the gas flow passage is 5.5 inches, the first vane diameter is smaller than 5.5 inches.

Each subsequent vane of the plurality of vanes 306, downstream from the first vane 330, has a diameter substantially equal to the first vane diameter. However, the last vane 332 of the plurality of vanes 306 is coupled to the wall 318 of the gas flow passage 304. Specifically, an outer edge of the last vane 332 is coupled to the wall 318. The last vane 332 blocks particles at the inner side 328 of the plurality of vanes 306 from traveling past the vanes 306 and downstream from the particle separator 300.

Gas flow 308 entering the particle separator may contain particles. As the gas flow 308 approaches the crown of the first vane 330, the gas flow 308 flows around and along the surface of the first vane 330. As the gas flow 308 flows around the first vane 330, the gas flow 308 gets closer to the wall 318 of the gas flow passage 304. The gas flow 308 then travels around and between the vanes 306, as shown by arrow 334. The angling of the vanes 306 forces the gas flow to bend around the corners of the angled vanes to pass from the outer side 326 of the vanes 306 to the inner side 328 of the vanes 306. Since the heavier particles (e.g., wear debris) in the gas flow 308 may not be able to bend and change direction, the particles may not pass through the vanes, thereby remaining on the outer side 326 of the vanes 306. In this way, the particle separating element 302 separates particles and/or debris traveling in the gas flow stream from the gas of the gas flow stream. Thus, the gas flow 336 exiting the particle separator 300 may have fewer particles (e.g., particles greater than the maximum particle size) than the gas flow 308 entering the particle separator 300.

As discussed above, particles may get trapped and remain on the outer side 326 of the vanes 306. The remaining particles then fall to a bottom 338 of the gas flow passage 304. Arrow 340 shows a possible flow path for the particles. As such, the bottom 338 of the gas flow passage 304 may be referred to as a particle trap. In one embodiment, an additional space or particle trap may be positioned at a side of the gas flow passage 304 for collecting and containing the trapped particles. In one example, the side may be a bottom side, with reference to a ground on which the vehicle in which the engine is installed sits, of the gas flow passage 304. In another example, the side may be a top side of the gas flow passage 304. In some embodiments, a magnet may be positioned at the bottom 338 of the gas flow passage 304 to attract and further collect magnetic particles. The magnet may be a flat, rod, or annular-shaped magnet. For example, an annular magnet, extending around a circumference of the gas flow passage 304, may be positioned at a downstream end of the particle separator to attract and trap metallic particles in the gas flow 308.

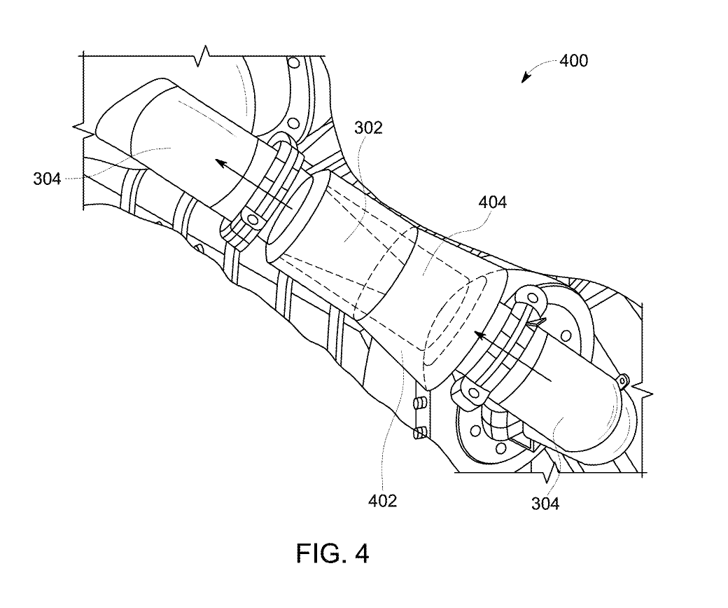

In another embodiment, a particle trap may be positioned around a circumference of the gas flow passage 304. In this embodiment, the particle trap has a larger diameter than the gas flow passage 304. An example of a particle separator 400 with such a particle trap is shown in FIG. 4. Specifically, FIG. 4 shows a schematic of the particle separator 400 coupled to and within a gas flow passage 304. The particle separator 400 may include similar elements to the particle separator 300, as described above with regard to FIG. 3. As described above, the particle separator 400 includes a particle separating element. The particle separator 400 further includes a particle trap 402. As mentioned above, the particle trap 402 is positioned around the circumference of a flow passage 404 of the particle separator 400. A diameter of the particle trap 402 is greater than a diameter of the flow passage 404. The particle trap 402 may include an annular magnet located at the base of the trap.

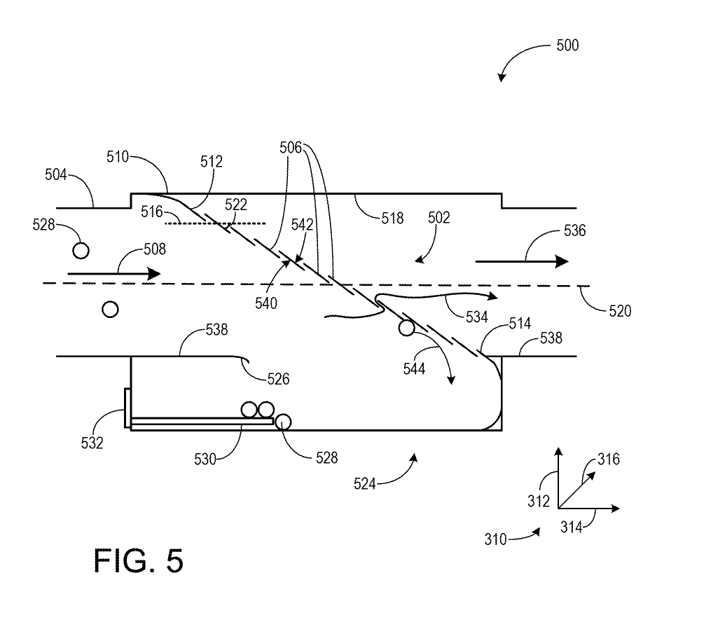

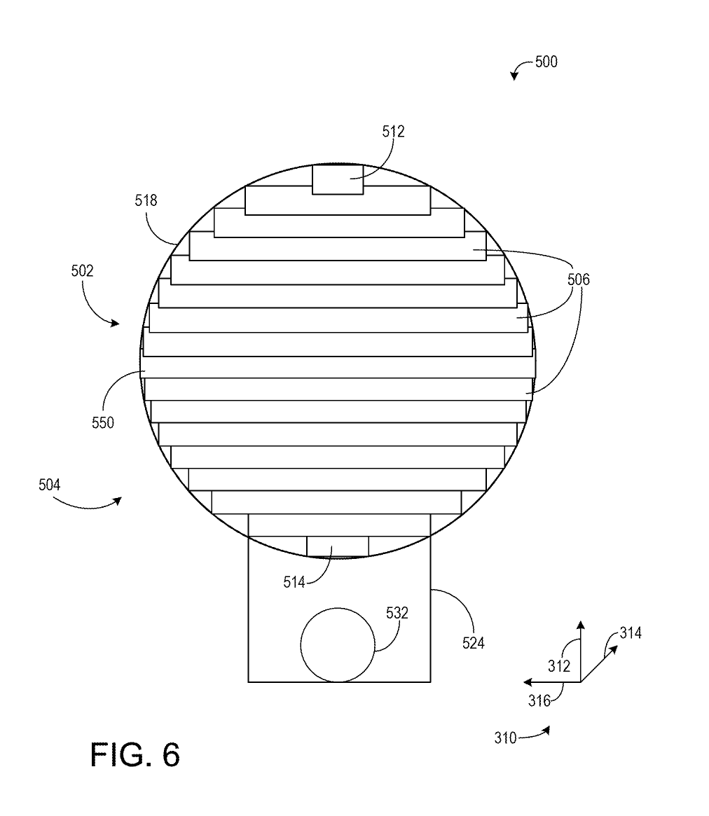

The particle trap 402 and/or the particle trap described above with reference to FIG. 3 may include an outlet port or opening for purging (e.g., removing) trapped particles from the particle trap. For example, as particles build up in the particle trap, the outlet port may be opened to remove particles from and empty the particle trap. Further details on the particle trap and outlet port are described below with reference to FIGS. 5-6.

FIGS. 5-6 show a second embodiment of an inertial-type particle separator 500. FIGS. 5-6 include a coordinate system 310 including a vertical axis 312, a horizontal axis 314, and a lateral axis 316. FIG. 5 is a side cross-sectional view of the particle separator 500. FIG. 6 shows a front (e.g., upstream) cross-sectional view of the particle separator 500.

As shown in FIGS. 5-6, the particle separator 500 includes a particle separating element 502 positioned within a gas flow passage 504. The gas flow passage 504 may be an EGR passage (such as EGR passage 132 shown in FIGS. 1-2) or an intake passage (such as intake passage 114 shown in FIGS. 1-2). Further, the gas flow passage 504 has a wall 518. The wall 518 is an interior wall forming a first diameter of the gas flow passage 504. Further, the wall 518 defines an interior of the gas flow passage 504.

The particle separating element 502 includes a plurality of overlapping and angled vanes 506. Specifically, the vanes 506 are linear slats which extend across a width of the gas flow passage 504. For example, each vane of the plurality of vanes 506 contacts a first point on the wall 518 and extends straight across the gas flow passage, in a lateral direction with respect to the lateral axis 316, from the first point to a second point on the wall 518. As such, each vane of the plurality of vanes 506 extends laterally across the gas flow passage 504.

The plurality of vanes 506 extend horizontally, with respect to the horizontal axis 314, across the gas flow passage 504 from a top 510 of the gas flow passage 504 at a first vane 512 of the plurality of vanes 506 to a bottom 538 of the gas flow passage 504 at a second vane 514 of the plurality of vanes 506. The bottom 538 of the gas flow passage 504 may be a side of the gas flow passage 504 closest to the ground on which the vehicle in which the engine is installed sits. As shown in FIG. 5, the second vane 514 is a last vane of the plurality of vanes 506. As such, the first vane 512 is coupled to the top 510 of the gas flow passage 504 and the second vane 514 is coupled to the bottom 538 of the gas flow passage. A distance between the first vane 512 and the second vane 514 defines a length of the particle separating element 502.

As shown in FIG. 6, the vanes 506 may vary in length, the length measured from the first point to the second point on the wall 518. For example, a middle vane 550, positioned at a center of the gas flow passage 504, has the longest length of all the vanes 506. The length of the middle vane is substantially the same as the first diameter of the gas flow passage 504. The first vane 512 and the second vane 514 have the shortest lengths of all the vanes 506. Thus, the length of the vanes 506 decreases as the vanes 506 approach the top 510 and the bottom 538 of the gas flow passage 504.

Each vane of the plurality of vanes 506 is angled with respect to a flow direction of a gas flow 508 flowing through the gas flow passage 504. As shown in FIG. 5, the flow direction of the gas flow 508 is in a horizontal direction, with respect to the horizontal axis 314. A central axis 520 of the gas flow passage 504 is parallel to the horizontal axis 314. Specifically, the central axis 520 is a central axis of the interior of the gas flow passage 504.

The vanes 506 are angled downward, toward the bottom 538 of the gas flow passage 504. Specifically, the vanes 506 are angled at an angle 522 measured from a horizontal vane axis 516. The horizontal vane axis 516 is centered vertically in a middle of each vane and parallel to the central axis 520. The angle 522 may be within a range of 30-75°. In one example, the angle 522, or a degree of angling of the vanes 506, may be 35°. In another example, the degree of angling of the vanes 506 may be 70°. Other degrees of angling are also within the scope of this disclosure.

In an alternate embodiment, the vanes 506 may be angled upward, toward the top 510 of the gas flow passage 504. In this embodiment, the first vane 512 may be coupled to the bottom 538 of the gas flow passage and the second vane 514 may be coupled to the top 510 of the gas flow passage. Further, the first vane 512 is also upstream of the second vane 514 in this embodiment.

As described above, the degree of angling may depend on a size of the particles that are to be separated from the gas flow. For example, the degree of angling may be determined such that no particles greater than a certain size (e.g., maximum particle size) may pass around and through the vanes 506 and exit the gas flow passage to enter the intake manifold of the engine. Similarly, a spacing between the vanes 506 may be determined based on the maximum particle size for particle separation. For example, the spacing between the vanes 506 may decrease as the maximum particle size decreases. Vane spacing and degree of angling may further be based on a gas flow resistance requirement. The vanes 506 may also have an amount of overlap. The amount of overlap of the vanes 506 may also be based on the maximum particle size and gas flow resistance.

The gas flow 508 entering the particle separator 500 may contain particles 528. As the gas flow 508 approaches the vanes 506, the gas flow 508 flows around and between the vanes 506, as shown by arrow 534. The angling of the vanes 506 forces the gas flow to bend around the corners of the angled vanes to pass from a first, upstream side 540 of the vanes 506 to a second, downstream side 542 of the vanes 506. Since the heavier particles 528 in the gas flow 508 may not be able to bend and change direction, the particles 528 may not pass through the vanes, thereby remaining on the upstream side 540 of the vanes 506. Additionally, particles 528 greater than the maximum particle size may not fit through the spaces between the vanes 506. In this way, the particle separating element 502 separates particles and/or debris traveling in the gas flow stream from the gas of the gas flow stream. Thus, the gas flow 536 exiting the particle separator 500 may have fewer particles 528 (e.g., particles greater than the maximum particle size) than the gas flow 508 entering the particle separator 500.

As discussed above, particles 528 may get trapped and remain on the upstream side 540 of the vanes 506. The remaining particles 528 then fall to the bottom 538 of the gas flow passage 504, as shown by arrow 544. As shown in FIG. 5, the particles 528 may be collected and trapped in a particle trap 524. The particle trap 524 is positioned in a side of the gas flow passage 504. Specifically, the particle trap 524 extends along the bottom 538 of the gas flow passage 504 for the distance between the first vane 512 and the second vane 514. In another example, the particle trap 524 may extend for a distance shorter or longer than the distance between the first vane 512 and the second vane 514.

As shown in FIGS. 5-6, the particle trap 524 is recessed from the gas flow passage 504. Specifically, the particle trap 524 extends outwardly from the wall 518 of the gas flow passage 504, at the bottom 538 of the gas flow passage 504. A lip 526 extends from the wall 518 at the bottom 538 of the gas flow passage 504 to retain collected particles 528 within the particle trap 524. In some examples, the particle trap 524 may include an additional lip or cover over a portion of the particle trap 524 for retaining trapped particles 528.

In an alternate embodiment, as described above, the vanes 506 may be angled upward, toward the top 510 of the gas flow passage 504 with the first vane 512 coupled to the bottom 538 of the gas flow passage 504 and the second vane 514 coupled to the top of the gas flow passage 504. In this embodiment, the particle trap 524 may extend outwardly from the wall 518 of the gas flow passage 504, at the top 510 of the gas flow passage 504.

As shown in FIG. 5, the particle trap 524 further includes a magnet 530 positioned at a bottom of the particle trap 524. The magnet 530 is a bar magnet coupled to an inside of the particle trap 524. In another example, the magnet 530 may be a circular, annular, or differently shaped magnet which fits inside the particle trap 524. The magnet 530 may attract particles 528, thereby aiding in the collection and trapping of separated particles 528.

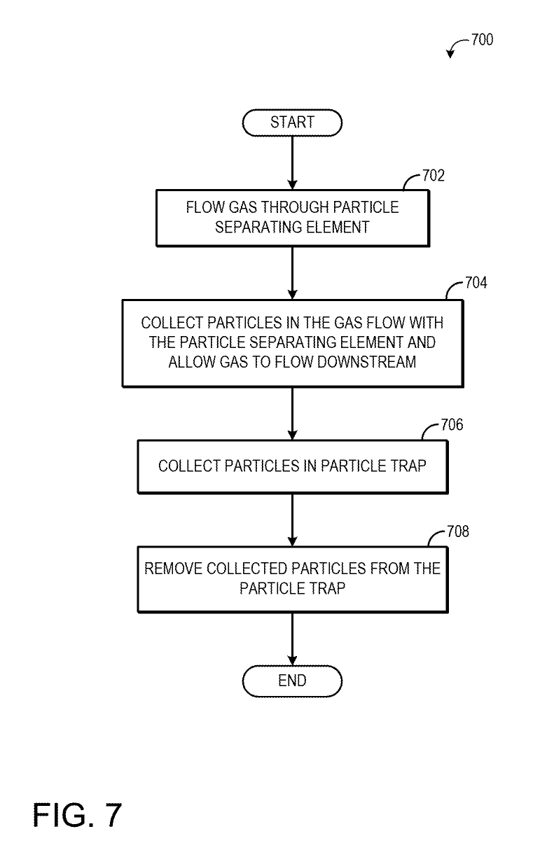

The particle trap 524 further includes an opening or outlet port 532 for removing collected particles 528 from the particle trap 524. The magnet 530 is positioned proximate to the outlet port 532. In another example, the magnet 530 may extend across a length of the particle trap 524. As particles 528 build up in the particle trap, the outlet port may be opened to remove particles 528 from and empty the particle trap. In one example, the particle trap 524 may be emptied manually by opening the outlet port 532 and removing the trapped particles 528. In another example, a hose or tube may be attached to the outlet port 532. This hose or ducting may lead to an area of lower pressure such as the outlet of the engine exhaust for purging the trapped particles. Suction may also be applied to the particle trap 524 to remove particles from the particle trap 524, through the outlet port 532 and attached tube. Further details on collecting and purging trapped particles are presented below with reference to FIG. 7.

FIG. 7 shows a method 700 for collecting particles in a gas flow with a particle separator. The method 700 begins at 702 by flowing gas through a particle separating element within a gas flow passage through which a gas flow passes. The gas flow passage may be an EGR passage or intake passage coupled to an engine. The particle separating element may include one or more of a filter, inertial, cyclonic, or vortex-type particle separator.

At 704, the method includes collecting particles is the gas flow with the particle separating element while allowing gas to flow downstream to an intake manifold of the engine. As described above, the particle separating element (such as the particle separating element 302 shown in FIG. 3 or the particle separating element 502 shown in FIG. 5) separates particles from the gas flow in the gas flow passage. As such, particles may remain at an upstream end of the particle separating element while gas flows through the particle separating element and downstream through the gas flow passage.

At 706, the method includes collecting particles in a particle trap. As described above, a particle trap may be positioned at a bottom of the gas flow passage. In one example, the particle trap may be recessed and extend outwardly from a wall of the gas flow passage. Particles which are unable to pass through the particle separating element may fall or flow into the particle trap. A magnet, lip, or other trapping element may then help to retain particles within the particle trap.

At 708, the method includes removing collected particles from the particle trap. In one example, the particle trap includes an outlet port positioned in a side of the particle trap. The outlet port may be opened to evacuate trapped particles from the particle trap. In another example, a suction tube may be coupled to the outlet port and used to draw out and purge particles from the particle trap. In yet another example, the entire particle trap may be manually removed from the particle separator and emptied when the vehicle is not running. After removing the collected particles at 708, the method ends.

An embodiment relates to a particle separator comprising a gas flow passage comprising a wall and an interior defined by the wall for passage of a gas flow, a plurality of vanes attached to the gas flow passage and positioned across the interior of the gas flow passage, the plurality of vanes angled with respect to a central axis of the interior, and a particle trap for collecting separated particles, the particle trap attached to the gas flow passage. The gas flow passage includes one or more of an exhaust gas recirculation passage, downstream of an exhaust gas recirculation cooler, an intake passage downstream of a charge air cooler and upstream of an outlet to the exhaust gas recirculation passage, or the intake passage downstream of the charge air cooler and the outlet to the exhaust gas recirculation passage. The plurality of vanes are overlapping and separated from one another by a distance. In one embodiment, the plurality of vanes are annular, with a diameter of the plurality of vanes being greater at a downstream end than an upstream end of the particle separator. At the upstream end, a first vane of the plurality of vanes includes a conical crown and at a downstream end, a second vane of the plurality of vanes is coupled to a wall of the gas flow passage. The plurality of vanes are angled toward the wall of the gas flow passage with a degree of angling, measured from a central axis of the gas flow passage and toward the wall of the gas flow passage, from 30 to 75 degrees. Additionally, the particle trap includes a magnet. Specifically, the magnet is an annular magnet positioned around a circumference of the wall of the gas flow passage.

In another embodiment, the plurality of vanes are linear slats positioned across the gas flow passage, extending from a top of the gas flow passage at a first vane of the plurality of vanes to a bottom of the gas flow passage at a second vane of the plurality of vanes. In this embodiment, the particle trap extends along the bottom of the gas flow passage for a distance between the first vane and the second vane and further includes a magnet positioned within the particle trap. The particle trap is recessed and extends outwardly from a wall of the gas flow passage and includes an outlet port for purging collected particles from the particle trap.

Another embodiment relates to a system comprising a flow passage coupled to an engine for passage of a gas flow comprising at least some exhaust gas and a particle separator positioned in the flow passage, the particle separator including a plurality of angled vanes across the flow passage and a particle trap positioned at a bottom of the flow passage, the particle trap including a magnet for attracting separated particles. The plurality of angled vanes are overlapping and gas flow bends around the plurality of angled vanes to pass from a first side of the plurality of angled vanes to as second side of the plurality of angled vanes. In a first embodiment, a first vane of the plurality of angled vanes includes a conical crown with a diameter smaller than the flow passage and a second vane of the plurality of angled vanes contacts a wall of the flow passage. In a second embodiment, the plurality of angled vanes are linear slats, the plurality of angled vanes extending across the flow passage with a first vane of the plurality of angled vanes coupled to a top of the flow passage and a second vane of the plurality of angled vanes coupled to a bottom of the flow passage.

In one embodiment, the flow passage is an exhaust gas recirculation passage and the particle separator is positioned downstream from an exhaust gas recirculation cooler in the exhaust gas recirculation passage. In another embodiment, the flow passage is an intake passage and the particle separator is positioned downstream of a charge air cooler and an outlet of an exhaust gas recirculation passage.

A further embodiment relates to a method for separating particles from a gas flow comprising collecting particles from a gas using a particle separating element, the gas flowing through a gas flow passage and containing at least some exhaust gas, wherein the particles are collected while allowing the gas to flow downstream to an intake manifold of an engine and wherein the particle separating element comprises at least one of an inertial particle separating element configured to block the particles which subsequently disengage from the gas and collect at a bottom of the gas flow passage, or a vortex particle separating element configured to produce a rotating flow on the gas as it passes through the vortex particle separating element. The particles are collected in a particle trap disposed in the gas flow passage, the particle trap including a magnet. The method further comprises removing collected particles from the particle trap through an outlet port of the particle trap.

In embodiments, one or more portions of a particle separator as set forth herein, through which a main flow of gas (e.g., gas along a central axis of the gas flow passage) passes when the particle separator is installed and the gas is flowing, are not configured to trap and hold particles. For example, the vanes as described herein may not be configured to trap and hold particles; instead, the particles strike the vanes and fall downwards for collection in the particle trap.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A particle separator, comprising:
a gas flow passage comprising a wall and an interior defined by the wall for passage of a gas flow;
a plurality of vanes attached to the gas flow passage and positioned across the interior of the gas flow passage, the plurality of vanes angled with respect to a central axis of the interior; and
a particle trap for collecting separated particles, the particle trap attached to the gas flow passage.

2. The particle separator of claim 1, wherein the plurality of vanes are overlapping and separated from one another by a distance.

3. The particle separator of claim 2, wherein the plurality of vanes are annular, with a diameter of the plurality of vanes being greater at a downstream end than an upstream end of the particle separator.

4. The particle separator of claim 3, wherein at the upstream end, a first vane of the plurality of vanes includes a conical crown and at a downstream end, a second vane of the plurality of vanes is coupled to a wall of the gas flow passage.

5. The particle separator of claim 4, wherein the particle trap includes a magnet.

6. The particle separator of claim 5, wherein the magnet is an annular magnet positioned around a circumference of the wall of the gas flow passage.

7. The particle separator of claim 4, wherein the plurality of vanes are angled toward the wall of the gas flow passage with a degree of angling, measured from the central axis and toward the wall of the gas flow passage, from 30 to 75 degrees.

8. The particle separator of claim 2, wherein the plurality of vanes are linear slats positioned across the gas flow passage, extending from a top of the gas flow passage at a first vane of the plurality of vanes to a bottom of the gas flow passage at a second vane of the plurality of vanes.

9. The particle separator of claim 8, wherein the particle trap extends along the bottom of the gas flow passage for a distance between the first vane and the second vane and further includes a magnet positioned within the particle trap.

10. The particle separator of claim 9, wherein the particle trap is recessed and extends outwardly from the wall of the gas flow passage and includes an outlet port for purging collected particles from the particle trap.

11. The particle separator of claim 1, wherein the gas flow passage includes one or more of an exhaust gas recirculation passage downstream of an exhaust gas recirculation cooler, an intake passage downstream of a charge air cooler and upstream of an outlet to the exhaust gas recirculation passage, or the intake passage downstream of the charge air cooler and downstream of the outlet to the exhaust gas recirculation passage.

12. A system, comprising:
a flow passage coupled to an engine for passage of a gas flow comprising at least some exhaust gas; and
a particle separator positioned in the flow passage, the particle separator including a plurality of angled vanes across the flow passage and a particle trap positioned at a bottom of the flow passage for trapping separated particles.

13. The system of claim 12, wherein the particle trap includes a magnet for attracting the separated particles.

14. The system of claim 12, wherein the plurality of angled vanes are overlapping and wherein a first vane of the plurality of angled vanes includes a conical crown with a diameter smaller than the flow passage and a second vane of the plurality of angled vanes contacts a wall of the flow passage.

15. The system of claim 12, wherein the plurality of angled vanes are overlapping linear slats, the plurality of angled vanes extending across the flow passage with a first vane of the plurality of angled vanes coupled to a top of the flow passage and a second vane of the plurality of angled vanes coupled to a bottom of the flow passage.

16. The system of claim 12, wherein the flow passage is an exhaust gas recirculation passage and wherein the particle separator is positioned downstream from an exhaust gas recirculation cooler in the exhaust gas recirculation passage.

17. The system of claim 12, wherein the flow passage is an intake passage and wherein the particle separator is positioned downstream of a charge air cooler and an outlet of an exhaust gas recirculation passage.

18. A method, comprising:
collecting particles from a gas using a particle separating element, the gas flowing through a gas flow passage and containing at least some exhaust gas, wherein the particles are collected while allowing the gas to flow downstream to an intake manifold of an engine, and wherein the particle separating element comprises at least one of an inertial particle separating element configured to block the particles which subsequently disengage from the gas and collect at a bottom of the gas flow passage, or a vortex particle separating element configured to produce a rotating flow on the gas as it passes through the vortex particle separating element.

19. The method of claim 18, wherein the particles are collected in a particle trap disposed in the gas flow passage, the particle trap including a magnet.

20. The method of claim 19, further comprising removing collected particles from the particle trap through an outlet port of the particle trap.
